(19) United States
(12) Patent Application Publication
(10) Pub. No.: US 2011/0153266 A1
(43) Pub. Date: Jun. 23, 2011

(54) AUGMENTED VEHICLE LOCATION SYSTEM

(75) Inventors: Craig Shankwitz, Minneapolis, MN (US); Bryan Newstrom, Circle Pines, MN (US); Edmund Arpin, Roseville, MN (US)

(73) Assignee: REGENTS OF THE UNIVERSITY OF MINNESOTA, St. Paul, MN (US)

(21) Appl. No.: 12/974,339

(22) Filed: Dec. 21, 2010

Related U.S. Application Data
(60) Provisional application No. 61/289,757, filed on Dec. 23, 2009.
(60) Provisional application No. 61/297,111, filed on Jan. 21, 2010.

(51) Int. Cl. G06F 19/00; G06F 15/00

(52) U.S. Cl. 702/150; 702/94

(57) ABSTRACT

A system comprises a mobile vehicle, a global positioning system (GPS) based vehicle position and heading system, at least one two-dimensional (2D) velocity sensor, a yaw rate system, and a vehicle position and heading estimator. The GPS based vehicle position and heading system is supported on the vehicle and measures global easting and global northing (measured position) of the vehicle, and determines a heading (measured heading) of the vehicle. The 2D velocity sensor measures the velocity of the vehicle with respect to the ground, over which the vehicle travels, in two orthogonal directions (measured velocity). The yaw rate system is supported on the vehicle and measures a yaw rate of the vehicle (yaw rate measurement). The vehicle position and heading estimator comprises at least one processor that computes a position of the vehicle (estimated position) and a heading of the vehicle (estimated heading) based on the measured position, the measured heading, the measured velocity and the yaw rate measurement.

### CROSS-REFERENCE TO RELATED APPLICATION

The present application is based on and claims the benefit of U.S. provisional patent application Ser. No. 61/289,757, filed Dec. 23, 2009 and U.S. provisional patent application Ser. No. 61/297,111, filed Jan. 21, 2010, the content of each provisional application, is hereby incorporated by reference in its entirety.

### FIELD

Embodiments of the invention generally relate to global positioning system (GPS) based vehicle location systems and, more particularly to an augmented GPS based vehicle location system configured to provide vehicle position estimates in GPS dead zones.

### BACKGROUND

Conventional vehicle location systems include GPS to locate the position of the vehicle on the surface of the earth. Such systems generally include an antenna and a receiver for receiving signals from GPS satellites and determining a location of the vehicle based on the signals.

The ability of the GPS to determine a solution for the location of the vehicle is dependent upon an unobstructed line of sight between the antenna and multiple GPS satellites. Unfortunately, in many roadway environments, short term (less than 200 meter) GPS dead zones prevent GPS position solutions. GPS dead zones occur where the antenna is obstructed from receiving the satellite signals, such as under bridges, on roads having tree canopies, roads through urban canyons, and other locations where line-of-sight view from the satellite to the antenna is obstructed. Degraded GPS solutions, ranging from no solution to solution qualities inferior to fixed integer carrier phase solutions, can last from a few seconds to minutes.

### SUMMARY

Embodiments of the invention are directed to systems and methods for providing vehicle position estimates in GPS dead zones. One embodiment of the system comprises a mobile vehicle, a global positioning system (GPS) based vehicle position and heading system, at least one two-dimensional (2D) velocity sensor, a yaw rate system, and a vehicle position and heading estimator. The GPS based vehicle position and heading system is supported on the vehicle and measures global easting and global northing (measured position) of the vehicle, and determines a heading (measured heading) of the vehicle. The 2D velocity sensor measures the velocity of the vehicle with respect to the ground, over which the vehicle travels, in two orthogonal directions (measured velocity). The yaw rate system is supported on the vehicle and measures a yaw rate of the vehicle (yaw rate measurement). The vehicle position and heading estimator comprises at least one processor that computes a position of the vehicle (estimated position) and a heading of the vehicle (estimated heading) based on the measured position, the measured heading, the measured velocity and the yaw rate measurement.

In one embodiment of the method, a mobile vehicle is moved. Global positioning system (GPS) based measurements are then performed at a first frequency using at least one GPS receiver and at least one antenna supported on the vehicle including measuring a position of the vehicle (measured position) and a heading of the vehicle (measured heading). Between successive GPS based measurements, a position of the vehicle is estimated based on the measured position, the measured heading, a two-dimensional velocity measurement of the vehicle and a yaw rate measurement of the vehicle, using at least one processor supported on the vehicle.

Other features and benefits that characterize embodiments of the present invention will be apparent upon reading the following detailed description and review of the associated drawings.

### BRIEF DESCRIPTION OF THE DRAWINGS

FIG. 1 is a simplified illustration of an augmented vehicle location system supported on a mobile vehicle.

FIG. 2 is a simplified diagram of an augmented vehicle location system in accordance with embodiments of the invention.

FIG. 3 is a simplified top view of an augmented vehicle location system supported on a mobile vehicle.

FIG. 4 is a simplified top view of a mobile vehicle illustrating local and state plane coordinate frames.

FIG. 5 is a simplified diagram illustrating a “back-looking” propagation algorithm used to establish a measured heading for a mobile vehicle.

FIGS. 6A-C are simplified top views of a yaw rate system in accordance with embodiments of the invention supported on a mobile vehicle.

FIG. 7 is a simplified block diagram of a vehicle position and heading estimator in accordance with embodiments of the invention.

FIG. 8 is a flow chart illustrating the selection of the observation error covariance R using one or more metrics.

### DETAILED DESCRIPTION OF ILLUSTRATIVE EMBODIMENTS

Embodiments of the invention relate to an augmented vehicle location system that calculates real-time, high accuracy (e.g., centimeter level) estimates of a global vehicle position by fusing GPS position measurements, vehicle heading measurements, yaw rate measurements, and/or two-dimensional velocity measurements. In one embodiment, the augmented vehicle location system estimates a heading of the vehicle based upon one or more of these measurements. The augmented vehicle location system is useful in providing vehicle position estimates in environments where spatially periodic GPS dead zones exist.

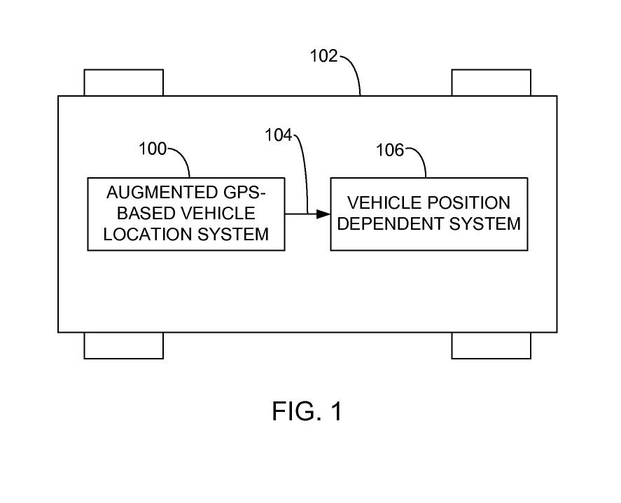

FIG. 1 is a simplified illustration of the augmented vehicle location system 100 supported on a mobile vehicle 102. The mobile vehicle 102 is generally configured for movement over a surface. In one embodiment, the mobile vehicle 102 is a motorized vehicle, such as a bus, a car, a motorcycle, a robotic device, or other motorized vehicle. In another embodiment, the mobile vehicle 102 is a non-motorized vehicle, such as a bicycle or other non-motorized vehicle.

In one embodiment, the system 100 provides vehicle position information 104 to a vehicle position dependent system 106. The system 106 may be in the form of a navigational system, a vehicle automation system, a lane departure warning system, a crash avoidance system, a mobility assist device (see, for example, U.S. Pat. No. 6,977,630) or other vehicle position dependent system that may benefit from the position information 104 generated by the augmented vehicle location system 100.

The position information 104 generated by the augmented vehicle location system 100 may also be provided to GPS receivers to accelerate the convergence of a vehicle position solution after a loss of satellite lock (i.e., the passage through a dead zone). With a typical GPS outage duration of fifteen seconds, the system 100 can provide accurate position estimates that reduce the size of the error sphere associated with the seed of the convergence algorithm. By minimizing the size of the initial search space, a more rapid convergence can be achieved. Thus, in one embodiment, the vehicle position dependent system 106 represents one or more GPS receivers, which may include those used by the system 100.

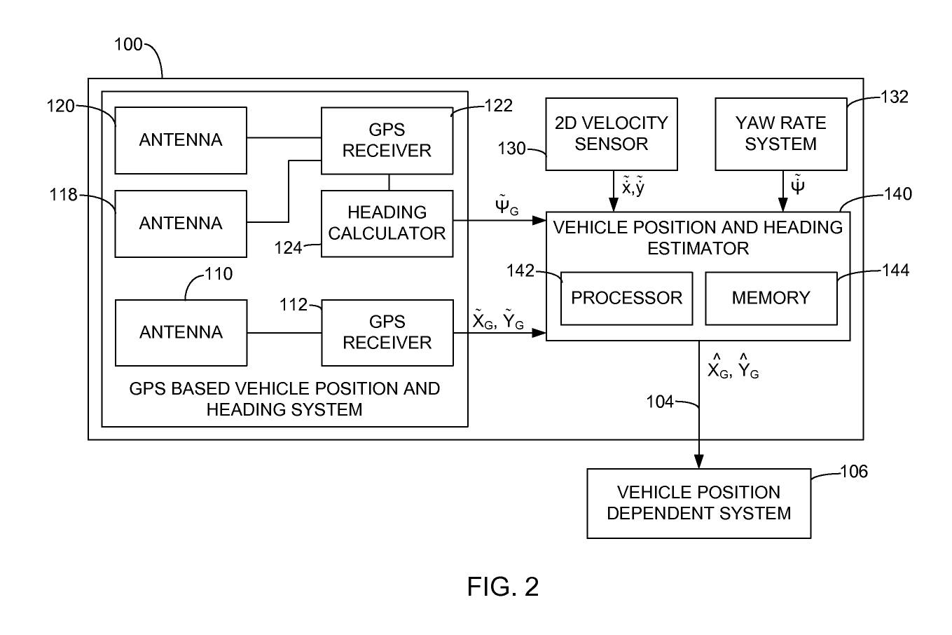

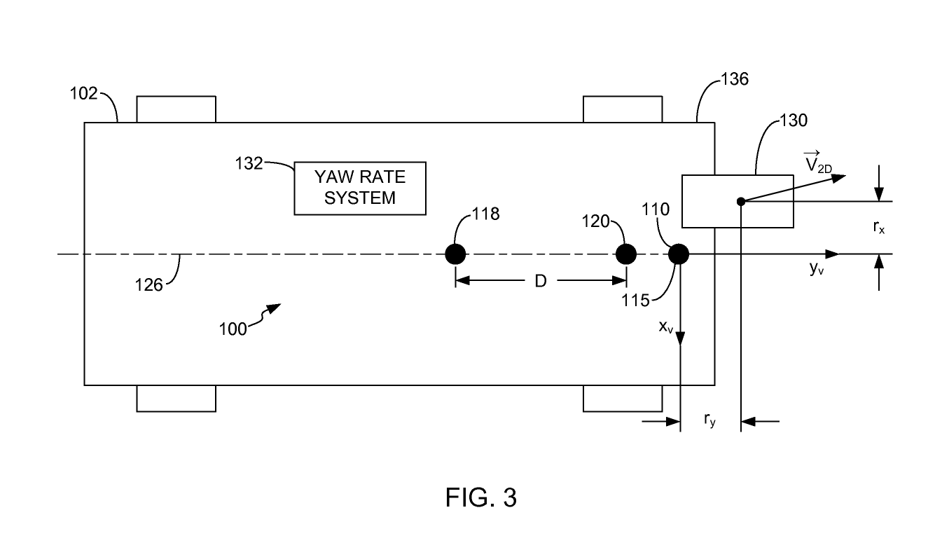

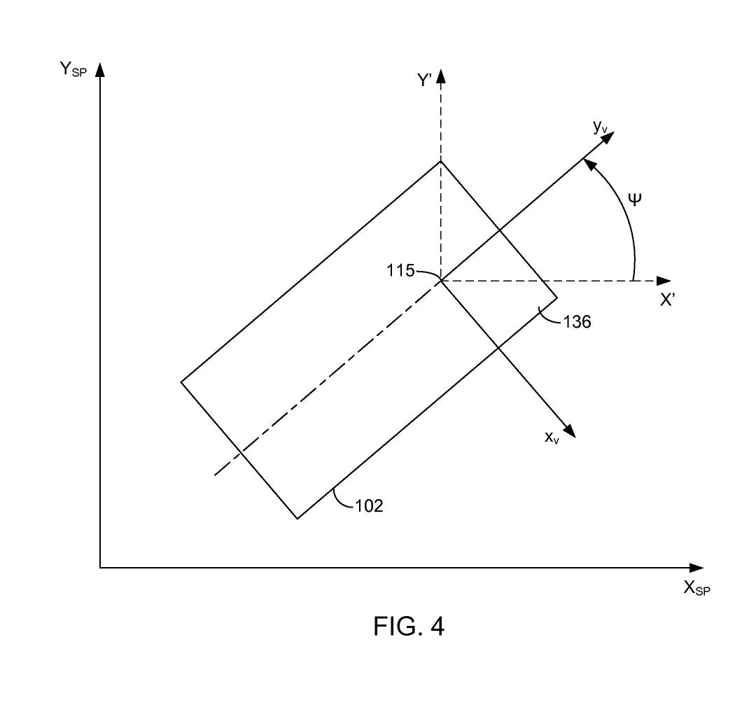

FIG. 2 is a simplified diagram of the augmented vehicle location system 100 in accordance with embodiments of the invention. FIG. 3 is a simplified top view of the augmented vehicle location system 100 supported on the mobile vehicle 102. FIG. 4 is a simplified top view of the vehicle 102 illustrating local and state plane coordinate frames.

Embodiments of the system 100 comprise a GPS based vehicle position and heading system 108, at least one two-dimensional (2D) velocity sensor 130, and a yaw rate system 132. The GPS based vehicle position and heading system 108 measures global easting and global northing (hereinafter “measured position”) of the mobile vehicle 102, and determines a measured heading of the vehicle 102. The 2D velocity sensor 130 measures the velocity of the vehicle 102 relative to the ground in two orthogonal directions. The yaw rate system measures a yaw rate of the vehicle 102.

One embodiment of the GPS based vehicle position and heading system 108 includes an antenna 110 and a GPS receiver or unit 112. In one embodiment, the antenna 110 is mounted at a point of interest 115 (FIGS. 3 and 4) on the vehicle 102 where the origins of a translated state plane coordinate system and a local coordinate frame for the vehicle are located. The GPS receiver 112 represents the processor and other components that are used to calculate the measured position of the antenna 110 based on satellite signals received by the GPS receiver 112 through the first antenna 110 in accordance with conventional systems. In one embodiment, the first antenna 110 comprises a dual frequency, carrier phase GPS antenna. One exemplary GPS receiver that may be used as the GPS receiver 112 is the Trimble R7 digital GPS receiver. Other components that are capable of providing the desired measured position may also be used in the system 108.

As mentioned above, the GPS based vehicle position and heading system 108 is supported on the mobile vehicle 102 and determines the measured heading Ψ of the vehicle 102 (FIG. 4), which is the angle between the direction in which the vehicle 102 is traveling to the state plane coordinate system (X′-Y′ axes) at the, for example, point of interest 115 of the vehicle 102. In one embodiment, the system 108 includes antennas 118 and 120, a GPS receiver 122 and a heading calculator 124.

In one embodiment, the antennas 118 and 120 are each L1-frequency antennas, which are supported on the vehicle 102, as illustrated in the simplified top view provided in FIG. 3. In one embodiment the antennas 118 and 120 are separated by distance D measured along an axis of the vehicle 102, such as the longitudinal axis 126 (FIG. 3), a lateral axis that is orthogonal to the longitudinal axis 126, or other predetermined axis of the vehicle. In one embodiment, the distance D is approximately two meters or greater. In one embodiment, the antennas 110, 118 and 120, and the point of interest 115 are aligned with the longitudinal axis 126 of the vehicle 102, as shown in FIG. 3.

In one embodiment, the heading calculator 124 represents one or more processors, memory, program instructions and other components that may be used to determine, using conventional techniques, the measured heading based on GPS signals received by the GPS receiver 122 through the antennas 118 and 120. In one embodiment, the GPS receiver 122 determines the measured heading by computing the arctangent of the vector between the position solution for antenna 118 and the position solution for antenna 120. One suitable heading calculator 124 is the Hemisphere Crescent Vector GPS receiver, which can provide both the measured position and heading.

In accordance with another embodiment, the system 108 includes antennas 110 and 118 and the GPS receivers 112 and 122, which may be components of a dual head receiver. The measured heading of the vehicle 102 is determine based on the signals received by the GPS receivers 112 and 122 through the antennas 110 and 118, respectively, in accordance with conventional techniques. Such techniques may involve, for example, the comparison of phase and timing information in addition to the calculation of the arctangent of the vector between the position solution for antenna 110 and the position solution for antenna 118.

In yet another embodiment, the heading calculator 124 of the system 108 calculates the heading of the vehicle 102 (i.e., the measured heading) using the measured position using the antenna 110 and the GPS receiver 112. The heading calculator 124 either includes a processor or utilizes another processor of the system 100 to calculate the measured heading using a “back-looking” propagation algorithm. The back propagation technique uses previously determined measured positions using the GPS receiver 112 to accurately determine the heading angle.

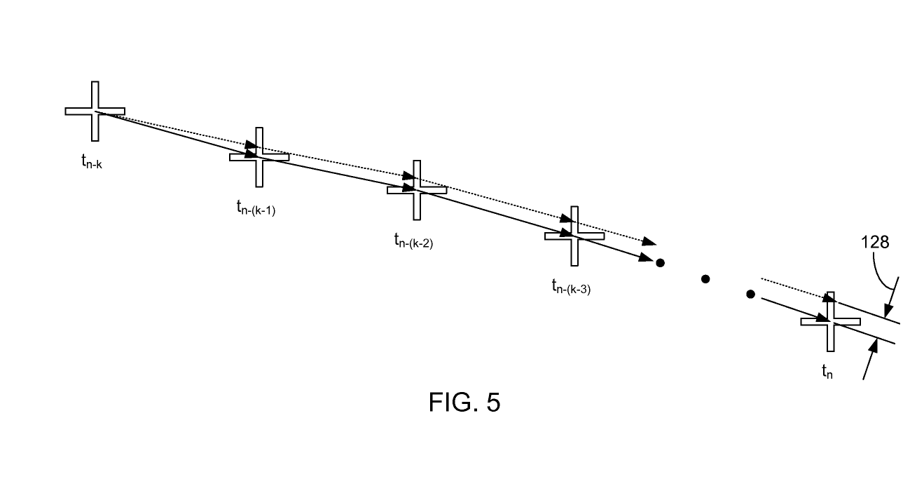

Consider the trajectory shown in the simplified diagram of FIG. 5. The heading measurement here is determined by propagating the measured position, represented by the crosses, at time tₙ₋ₖ and the estimated heading angle at tₙ₋₍ₖ₊₁₎ as initial conditions at time tₙ₋ₖ. From these initial conditions, the heading calculator 124 is used to propagate an estimated position (dashed line) at time tₙ. This estimated position at time tₙ is compared to the measured position at time tₙ; the difference between the estimated position and the measured position becomes the reference error 128 used to determine the heading error at time tₙ₋ₖ. The heading error estimate 128 at time tₙ is

$${tan}^{- 1} ( \frac{error}{Path Length} ) ,$$

where “Path Length” is the sum of the length of the trajectory line segments from time tₙ₋ₖ to tₙ.

The heading estimate error computed at time tₙ is applied to the heading estimate at time tₙ₋₍ₖ₊₁₎ to produce the optimal estimate of heading at time tₙ₋ₖ. Using the optimal estimate of heading at time tₙ₋ₖ as a new initial condition, the system 108 uses 2D-velocity and yaw rate measurements from the sensor 130 and the system 132 from time tₙ₋ₖ to tₙ to propagate forward in time to produce the optimal estimate of the heading of the vehicle 102 at time tₙ.

At each time step tₖ, this process is repeated, thereby providing a continuous stream of accurate measured heading estimates without the need for a separate specific, GPS-based heading estimator.

The 2D velocity sensor 130 is supported on the mobile vehicle 102 and measures the velocity of the vehicle 102 relative to the ground in two orthogonal directions (hereinafter “measured velocity”). As used herein, the sensor 130 represents one or more velocity sensors or other components that are used to obtain the velocity of the vehicle 102 relative to the ground in two orthogonal directions. This may be accomplished by measuring the velocity of the ground relative to the vehicle 102 and/or measuring the velocity of objects to the side of the vehicle 102, such as a guardrail, a wall, and/or an embankment, for example. One exemplary 2D velocity sensor 130 that is suitable for determining the measured velocity of the vehicle 102 is the Correvit S-350 Aqua Two-Dimensional Velocity Sensor.

In one embodiment, the velocity sensor 130 is mounted such that its coordinate frame is aligned with the local vehicle coordinate frame. In the event that the coordinate frame of the velocity sensor 130 is not aligned with a local vehicle frame, the measured velocity can be translated to the desired local coordinate frame using conventional techniques. In one embodiment, the sensor 130 is mounted at the front 136 of the vehicle 102.

The yaw rate system 132 that is supported on the vehicle 102 and measures a yaw rate Ψ of the vehicle (hereinafter “yaw rate measurement”), which is the rate of angular movement of the vehicle 102 about the z-axis (not shown), which is orthogonal to the x- and y-axes of the local coordinate frame (FIG. 4) of the vehicle 102. In one embodiment, the yaw rate system 132 comprises an inertial measurement unit that is mounted to the vehicle 102 and provides the yaw rate measurements. One exemplary inertial measurement unit that may be used in the system 132 is the Crossbow IMU440.

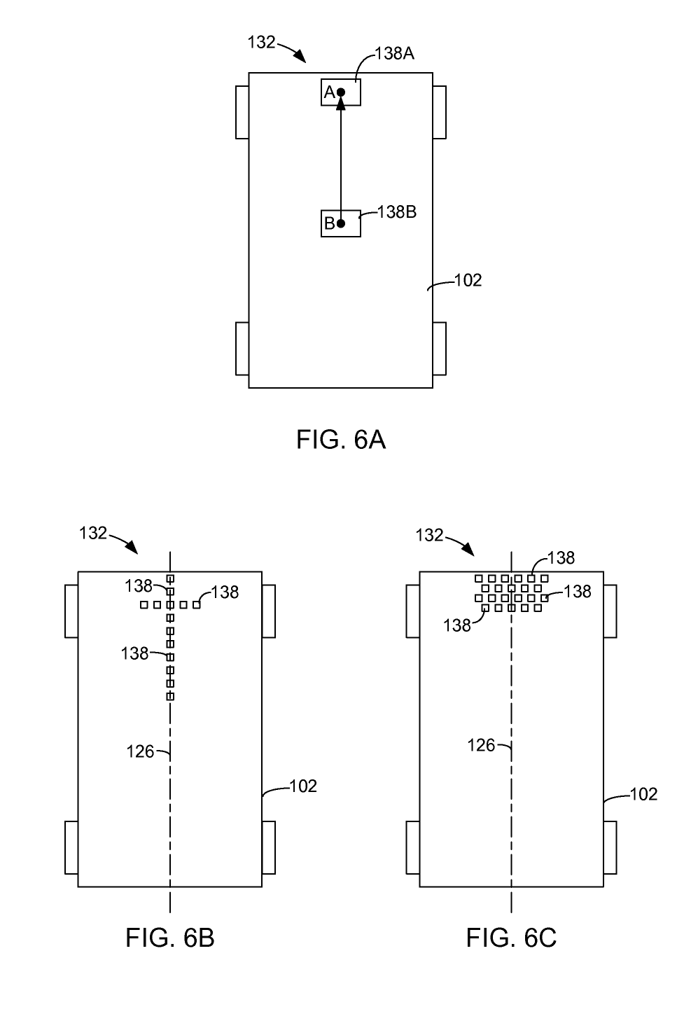

In accordance with another embodiment, the yaw rate system 132 comprises at least two 2D velocity sensors 138A and 138B supported on the mobile vehicle 102, as illustrated in the simplified diagram provided in FIG. 6A. In one embodiment, the 2D velocity sensor 130 is used as one of the velocity sensors 138A or 138B. In one embodiment, the yaw rate system 132 uses the velocity measurements taken by the at least two velocity sensors to calculate the yaw rate for the vehicle 102. In one embodiment, the yaw rate system 132 includes at least one processor, memory and program instructions stored in the memory and executable by the processor to perform the necessary calculations or the velocity measurements from the plurality of velocity sensors. Alternatively, the velocity measurements may be provided to another processor of the system 100 to perform the necessary calculations, which are explained below.

Consider the kinematics of a solid body translating and rotating on a plane, as shown in FIG. 6A. With \vec{V}ₐ representing the velocity at Point A, and \vec{V}_{b} representing the velocity at Point B, the velocity of Point B with respect to Point A is then

\vec{V}_{b}=\vec{V}ₐ+\vec{r}_{b/a}×ω (Eq. 1)

With \vec{r}_{b/a} known (the vehicle manufacturer knows where the sensors are located on the vehicle), Equation 1 is solved to determine \vec{ω}, the yaw rate of the vehicle.

In one embodiment, the yaw rate system 132 includes an array of more than two 2D sensors 138, as shown in FIGS. 6B and 6C, is used to compute a least squares optimal estimate of \vec{ω}. The use of these multiple sensors can minimize errors (i.e., by averaging the data from the multiple sensors), and can be used to compensate for non-rigid body dynamics (where the “twisting” of the vehicle body along the longitudinal axis 126 can produce measurement errors from the relative motion of the sensor induced by the twisting motion with respect to the road). Improved yaw rate measurements will produce improved vehicle position and heading estimates in the absence of GPS measurements.

It is understood that the exemplary components described above that are used to determine the measured heading of the vehicle 102, the measured position of the vehicle 102, the measured velocity of the vehicle 102 and the yaw rate measurement of the vehicle 102, may be substituted with other components that are capable of providing the desired measurements. Embodiments of the invention include the use of such substituted components. These other components may be capable of handling a combination of the desired measurements. For instance, an integrated digital GPS and inertial measurement unit, such as the Novatel UIMU-HG utilizing their Synchronous Position, Attitude and Navigation (SPAN) technology, may be used to determine the measured position, measured heading and yaw rate of the vehicle 102. Thus, while the diagram of FIG. 2 appears to illustrate the GPS based position and heading system 108 and the yaw rate system 132 to be distinct components, it is understood that the function of the illustrated components could be performed by one or more actual components.

Additionally, more accurate technologies may be utilized as they are developed to obtain the desired measurements. For instance, embodiments of the invention may make use of current and future GPS technologies such as L1, L2 and L5 technologies, to provide the desired measured position accuracy. Thus, for example, the L5 technology may be used to provide high accuracy position measurements (˜10-30 cm) without the need for differential GPS corrections.

In one embodiment, the system 100 includes a vehicle position and heading estimator 140, which comprises at least one processor 142. In one embodiment, the vehicle position and heading estimator 140 includes a memory 144. In one embodiment, the memory 144 includes program instructions that are executable by the processor 142 to process data and perform method steps described herein.

The general convention used herein is to cap a measurement variable with a tilde (˜) and an estimated value with a hat (̂). If the value is not capped it denotes the true value. For example, X_{G} is the global easting position in state plane coordinates, so \tilde{X}_{G} is the measured value from GPS and \hat{X}_{G} is the estimated value of global easting from the estimator 140. The following will be the variable notation used herein.

1. Coordinate Frames
1.1. X_{SP} Y_{SP}: State plane coordinate system, shown in FIG. 4
1.2. xᵥ yᵥ: Local vehicle coordinate frame (preferably located at the point of interest 115, yᵥ is preferably parallel to the longitudinal axis 126)
1.3. X′ Y′: State plane coordinate system translated to the point of interest 115

2. States
2.1. X_{G,k}: Global Easting of the vehicle with respect to the state plane coordinate system at time step k
2.2. Y_{G,k}: Global Northing of the vehicle with respect to the state plane coordinate system at time step k
2.3. Ψₖ: Vehicle Heading as seen in FIG. 4 (angle between yᵥ axis and East, positive direction is counter-clockwise) at time step k
2.4. \dot{Ψ}_{b,k}: Yaw rate bias at time step k

3. Measurements
3.1: {dot over (\tilde{Ψ}ₖ: Yaw rate measurement from yaw rate sensor at time step k
3.2: {dot over (\tilde{x}ₖ: Measured velocity parallel to the local vehicle xᵥ-axis (measured by 2D velocity sensor 130) at time step k
3.3. {dot over (\tilde{y}ₖ: Measured velocity parallel to the local vehicle yᵥ-axis (measured by 2D velocity sensor 130) at time step k
3.4. \tilde{X}_{G,k}: GPS measurement of global Easting from the front GPS unit 112 (state plane coordinates) at time step k
3.5. \tilde{Y}_{G,k}: GPS measurement of global Northing from the front GPS unit 112 (state plane coordinates) at time step k
3.6. \tilde{Ψ}_{C,k}: Vehicle heading measurement at time step k

4. Inputs
4.1. {dot over (\tilde{Ψ}ₖ
4.2. {dot over (\tilde{x}ₖ

In accordance with one embodiment, as the vehicle 102 is moved, the GPS based vehicle position and heading system 108 determines the measured position (\tilde{X}_{G}, \tilde{Y}_{G}) of the vehicle 102 and the measured heading (\tilde{Ψ}) of the vehicle at a first frequency (e.g., 10 Hz) based on GPS measurements (i.e., processing of GPS satellite signals). Between successive GPS based measurements using the system 108, the vehicle position and heading estimator 140 computes an estimated position (\hat{X}_{G}, Ŷ_{G}) of the vehicle 102 and an estimated heading (\hat{Ψ}) of the vehicle 102 based on the measured position and heading from the GPS based position and heading system 108, the measured velocity ({dot over (\tilde{x}, {dot over (\tilde{y}) from the 2D velocity sensor 130, and the yaw rate measurement ({dot over (\tilde{Ψ}) from the yaw rate system 132, using the processor 142. Details of the various measurements and the processing steps used to calculate the estimated vehicle position are provided below.

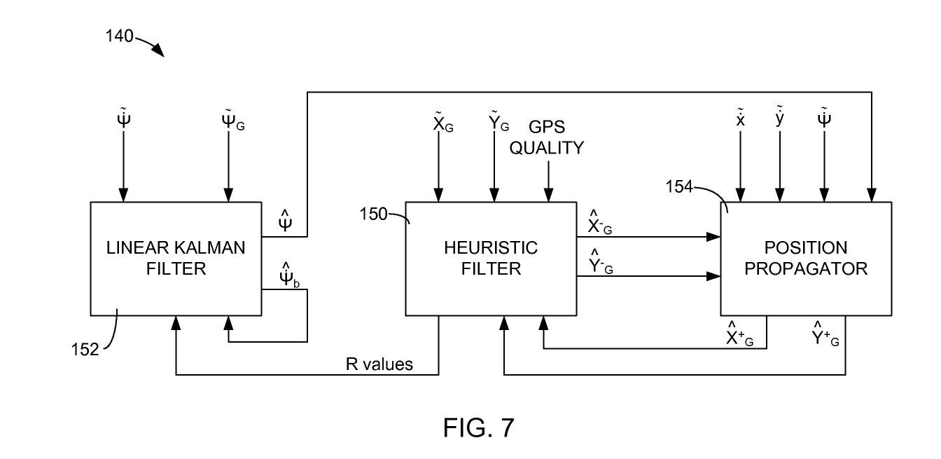

The estimator 140 can generally be split into three separate parts; a heuristic filter 150, a linear Kalman filter 152, and a position propagator 154, which are illustrated in the simplified block diagram of FIG. 7. Each time a measured position (\tilde{X}_{G,k}, \tilde{Y}_{G,k}) becomes available from the GPS based position and heading system 108, the heuristic filter 150 updates the position estimate and determines the measurement error covariance (R values) of the vehicle heading measurement for the linear Kalman Filter 152. The linear Kalman filter 152 computes an optimal estimate of the vehicle heading \hat{Ψ} and an optimal estimate of the yaw rate sensor bias {dot over (\hat{Ψ}_{b}.

In between GPS based vehicle position measurement updates by the system 108, the position estimate is propagated from the yaw rate system 132 measurement and the 2D velocity sensor 130 measurements at a second frequency (e.g., 100 Hz) by the position propagator 154. This process is generally depicted in FIG. 7. A description of the calculations and method steps performed by the estimator 140 in accordance with embodiments of the invention is provided below.

The position state equations are used by the position propagator 154 to propagate the state estimates X_{G,k} and Y_{G,k} between GPS measurements of the system 108. The other states, Ψₖ and \dot{Ψ}_{b,k}, are updated by the linear Kalman filter 152. The state matrix for the position propagator 154 is defined as,

$${x}_{P , k} = [ \begin{matrix}{X}_{G , k} \\ {Y}_{G , k}\end{matrix} ] \qquad ( Eq . 2 )$$

Equations 3 and 4 are the derivation of the state equations for the system.

$$\begin{matrix}{\hat{x}}_{P , k + 1} = {\hat{x}}_{P , k} + Δ {t}_{k} \cdot {{x}^{\hat{.}}}_{P , k} & ( Eq . 3 ) \\ {{x}^{\hat{.}}}_{P , k} = [ \begin{matrix}{{X}^{\hat{.}}}_{G , k} \\ {{Y}^{\hat{.}}}_{G , k}\end{matrix} ] & ( Eq . 4 )\end{matrix}$$

Here \hat{x}_{p,k+1} is the state matrix estimate at time step k+1, Δtₖ is the difference in time between time steps k and k+1, and {dot over (\hat{x} is the rate of the change of the estimated state matrix with respect to time.

The 2D velocity sensor 130 measures its velocity vector

$${{V}^{\tilde{\to }}}_{2 D} = [ \begin{matrix}{x}^{\tilde{.}} \\ {y}^{\tilde{.}} \\ 0\end{matrix} ] ,$$

at its location on the vehicle. Note that the speed in the z dimension is not measured by the 2D speed sensor, thus it is shown as zero. Equation 5 translates the measured velocity at the velocity sensor 130, {right arrow over (\tilde{V}_{2D}, to the velocity at the local vehicle coordinate frame at time step k, {right arrow over (\tilde{V}_{v,k},

$${{V}^{\tilde{\to }}}_{v , k} = {{V}^{\tilde{\to }}}_{2 D , k} - {\vec{ω}}_{k} \times \vec{R} = [ \begin{matrix}{x}^{\tilde{.}} + {r}_{y} {Ψ}^{\hat{.}} \\ {y}^{\tilde{.}} - {r}_{x} {Ψ}^{\hat{.}} \\ 0\end{matrix} ] \qquad ( Eq . 5 )$$

where

$$\vec{R} = [ \begin{matrix}{r}_{x} \\ {r}_{y} \\ 0\end{matrix} ]$$

and rₓ and r_{y} are shown in FIG. 1, and where

$$ω = [ \begin{matrix}0 \\ 0 \\ {Ψ}^{\hat{.}}\end{matrix} ] .$$

Moreover, {dot over (\hat{Ψ}ₖ={dot over (\tilde{Ψ}ₖ−{dot over (\hat{Ψ}_{b}_{ₖ}, or the estimate of the vehicle's yaw rate at time step k.

To transform the local vehicle velocity, \vec{V}_{v,k}, to the global state plane velocity, we must pre-multiply \vec{V}_{v,k} by the rotation matrix,

$$\begin{matrix}[ \begin{matrix}sin ( {\hat{Ψ}}_{k} ) & cos ( {\hat{Ψ}}_{k} ) & 0 \\ - cos ( {\hat{Ψ}}_{k} ) & sin ( {\hat{Ψ}}_{k} ) & 0 \\ 0 & 0 & 0\end{matrix} ] . Thus , & \\ {{X}^{\hat{.}}}_{G , k} = ( {{x}^{\tilde{.}}}_{k} + {r}_{y} {{Ψ}^{\hat{.}}}_{k} ) sin ( {\hat{Ψ}}_{k} ) + ( {{y}^{\tilde{.}}}_{k} - {r}_{x} {{Ψ}^{\hat{.}}}_{k} ) cos ( {\hat{Ψ}}_{k} ) & ( Eq . 6 ) \\ {{Y}^{\hat{.}}}_{G , k} = - ( {{x}^{\tilde{.}}}_{k} + {r}_{y} {{Ψ}^{\hat{.}}}_{k} ) cos ( {\hat{Ψ}}_{k} ) + ( {{y}^{\tilde{.}}}_{k} - {r}_{x} {{Ψ}^{\hat{.}}}_{k} ) sin ( {\hat{Ψ}}_{k} ) & ( Eq . 7 )\end{matrix}$$

Putting the state equations into discrete matrix form leads to Equation 8.

$$\begin{matrix}{\hat{x}}_{P , k + 1} = [ \begin{matrix}{\hat{X}}_{G , k + 1} \\ {\hat{Y}}_{G , k + 1}\end{matrix} ] \\ = [ \begin{matrix}{\hat{X}}_{G , k} \\ {\hat{Y}}_{G , k}\end{matrix} ] + \\ Δ t [ \begin{matrix}( {{x}^{\tilde{.}}}_{k} + {r}_{y} {{Ψ}^{\hat{.}}}_{k} ) sin ( {\hat{Ψ}}_{k} ) + ( {{y}^{\tilde{.}}}_{k} - {r}_{x} {{Ψ}^{\hat{.}}}_{k} ) cos ( {\hat{Ψ}}_{k} ) \\ - ( {{x}^{\tilde{.}}}_{k} + {r}_{y} {{Ψ}^{\hat{.}}}_{k} ) cos ( {\hat{Ψ}}_{k} ) + ( {{y}^{\tilde{.}}}_{k} - {r}_{x} {{Ψ}^{\hat{.}}}_{k} ) sin ( {\hat{Ψ}}_{k} )\end{matrix} ]\end{matrix} \qquad ( Eq . 8 )$$

The Kalman filter 152 is responsible for producing a stochastically optimal estimate of the vehicle heading, \hat{Ψ}ₖ, and the yaw rate bias, {dot over (\hat{Ψ}ₖ. The state matrix of the linear Kalman filter 152 is provided in Equation 9.

$${x}_{KF , k} = [ \begin{matrix}{Ψ}_{k} \\ {\dot{Ψ}}_{b , k}\end{matrix} ] \qquad ( Eq . 9 )$$

The discrete system model is of the form,

x_{KF,k+1=Φ}ₖx_{KF,k}+Γuₖ+Yqₖ, wₖ˜N(0,Qₖ) (Eq. 10)

\tilde{y}ₖ=Hx_{KF,k}+vₖ, vₖ˜N(0,Rₖ) (Eq. 11)

where wₖ and vₖ are the input noise and measurement noise respectively; wₖ and vₖ are modeled by zero-mean Gaussian distributions. The input noise error covariance, Qₖ, is related to the error characteristics of the yaw rotational rate measurement from the inertial measurement unit of the yaw rate system 132. For the Crossbow Inertial Measurement Unit measuring vehicle yaw rate, the value Qₖ was determined to be 0.0045 rad²/s². Other values may be used depending on the inertial measurement unit. The observation noise, Rₖ, is related to the quality of the GPS measurements, and is determined by the heuristic filter 150, as explained below.

The system model for the linear Kalman filter 152 is provided in Equations 12 and 13.

$$\begin{matrix}[ \begin{matrix}{Ψ}_{k + 1} \\ {\dot{Ψ}}_{b , k + 1}\end{matrix} ] = [ \begin{matrix}1 & - Δ {t}_{k} \\ 0 & 1\end{matrix} ] [ \begin{matrix}{Ψ}_{k} \\ {\dot{Ψ}}_{b , k}\end{matrix} ] + [ \begin{matrix}Δ {t}_{k} \\ 0\end{matrix} ] {Ψ}^{\tilde{.}} + [ \begin{matrix}- Δ {t}_{k} \\ 0\end{matrix} ] {w}_{k} & ( Eq . 12 ) \\ {\tilde{y}}_{k} = {\tilde{Ψ}}_{C , k} = [ \begin{matrix}1 & 0\end{matrix} ] [ \begin{matrix}{Ψ}_{k} \\ {\dot{Ψ}}_{b , k}\end{matrix} ] + {v}_{k} & ( Eq . 13 )\end{matrix}$$

The state estimate \hat{x}_{KF}, and the state error covariance, Pₖ, are both propagated when a new yaw rate measurement is available (e.g., 100 Hz) and a measurement update is performed when a GPS measurement is available (e.g., 10 Hz). A summary of the state and state error covariance propagation, gain computation, and measurement update is shown in Table 1.

TABLE 1
Summary of linear Kalman filter steps

| | | |
|---|---|---|
| Gain | Kₖ = PₖH^{T}[HPₖH^{T} + Rₖ]⁻¹ | (Eq. 14) |
| Computation | | |
| Measurement | \hat{x}_{KF, k+1} = \hat{x}_{KF, k} + Kₖ[\tilde{y}ₖ − H\hat{x}_{KF, k}] | (Eq. 15) |
| Update | Pₖ₊₁ = [I − KₖH]Pₖ | (Eq. 16) |
| Propagation | \hat{x}_{KF, k+1} = Φₖ\hat{x}_{KF, k} + Γuₖ | (Eq. 17) |
| | Pₖ₊₁ = ΦₖPₖΦₖ^{T} + YQₖY^{T} | (Eq. 18) |

The heuristic filter block 150, shown in FIG. 7, determines the position update gain value, K_{PG,k}, and the vehicle heading observation error covariance (Rₖ values) for the position update equation and linear Kalman filter 152, respectively. When the position update gain value is determined, the heuristic filter 150 uses the incoming GPS position measurements,

$$[ \begin{matrix}{\tilde{X}}_{G , k} \\ {\tilde{Y}}_{G , k}\end{matrix} ] ,$$

to update the position estimates,

$$[ \begin{matrix}{\hat{X}}_{G , k} \\ {\hat{Y}}_{G , k}\end{matrix} ] ,$$

using Equation 19.

$$[ \begin{matrix}{\hat{X}}_{G , k}^{+} \\ {\hat{Y}}_{G , k}^{+}\end{matrix} ] = [ \begin{matrix}{\hat{X}}_{G , k}^{-} \\ {\hat{Y}}_{G , k}^{-}\end{matrix} ] + {K}_{PG , k} [ [ \begin{matrix}{\tilde{X}}_{G , k} \\ {\tilde{Y}}_{G , k}\end{matrix} ] - [ \begin{matrix}{\hat{X}}_{G , k}^{-} \\ {\hat{Y}}_{G , k}^{-}\end{matrix} ] ] \qquad ( Eq . 19 )$$

The position update gain and vehicle heading error covariance are selected based on the following metrics:
GPS quality—Ranges between fix, float, DGPS, autonomous, and no solution. The GPS receiver or unit used to establish the measured position of the vehicle 102, such as 112, may indicate a quality of the measurement, such as between autonomous and no solution. This quality value indicates whether GPS measurements were available to use in the heading solution heading calculator 124. A fix solution implies that the integer ambiguities in the carrier phase measurement have been solved with a certain level of confidence.
dₖ—The distance between the GPS measurement and the estimator's position estimate,

$$\vert [ \begin{matrix}{\tilde{X}}_{G , k} \\ {\tilde{Y}}_{G , k}\end{matrix} ] - [ \begin{matrix}{\hat{X}}_{G , k}^{-} \\ {\hat{Y}}_{G , k}^{-}\end{matrix} ] \vert$$

Heading Lock—When the GPS unit, such as 122, is used to establish the measured heading for the vehicle 102, there may be an indication as to whether the GPS heading solution has a lock. If the solution has a “heading lock,” it implies it is of high accuracy, with errors less than 0.1 degree rms.
{tilde over (\dot{Ψ}_{c,k}—The computed heading measurement derivative with respect to time:

$${{Ψ}^{\dot{\sim}}}_{C , k} = \frac{{\tilde{Ψ}}_{C , k} - {\tilde{Ψ}}_{C , k - 1}}{{t}_{k} - {t}_{k - 1}} \qquad ( Eq . 20 )$$

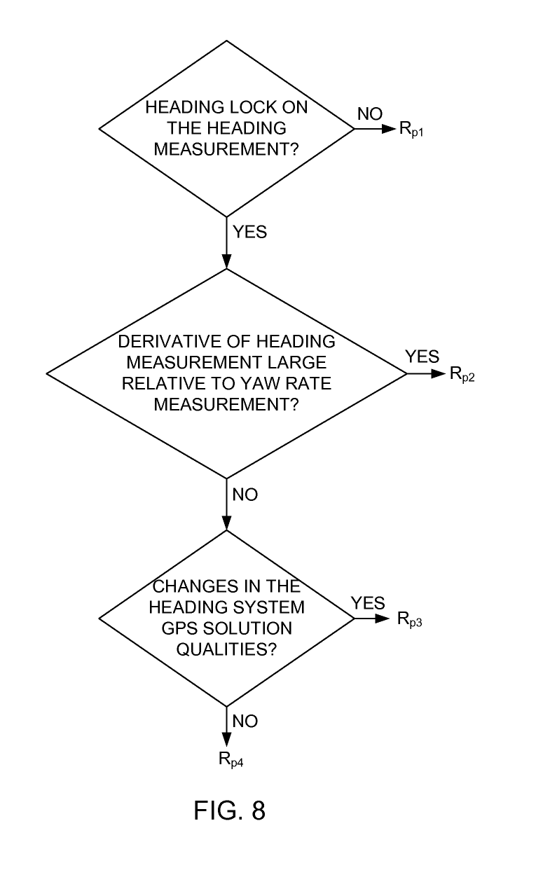

FIG. 8 is a flowchart illustrating an exemplary use of one or more of these metrics to select the observation error covariance R. At 160, the method determines whether there is a heading lock on the heading measurement. If there isn't a heading lock on the heading measurement, the observation error covariance is set to a predetermined value Rₚ₁, such as 100 rad²/s². If there is a heading lock on the heading measurement, a check is made at 162, whether the derivative of the heading measurement is large relative to the yaw rate measurement. In the event that the derivative of the heading measurement is large relative to the yaw rate measurement, the method sets the observation error covariance to a predetermined value Rₚ₂, such as 100 rad²/s². If the derivative of the heading measurement is not large relative to the yaw rate measurement, the method determines whether there are changes in the heading system GPS solution qualities, at 164. If there are changes in the heading system GPS solution qualities, the observation error covariance is set to a predetermined value Rₚ₃, such as 100 rad²/s². If there are no changes in the heading system GPS solution qualities, the observation error covariance is set to another predetermined value Rₚ₄, such as 0.122 rad²/s².

In one embodiment, the position update gain is selected based upon the front GPS quality metric. In one embodiment, if the front GPS quality metric is not “fix”, the position update gain is set to zero. If the front GPS quality metric is “fix”, the position update gain is selected based on the difference between the GPS position measurement and the position estimate dₖ.

Although the present invention has been described with reference to preferred embodiments, workers skilled in the art will recognize that changes may be made in form and detail without departing from the spirit and scope of the invention. It is understood that embodiments of the invention are directed to real-world applications, as opposed to a simulator or virtual world environments. That is, embodiments of the invention are for use on a mobile vehicle traveling over the surface of the earth. Additionally, it is understood that embodiments of the invention include the performance of the method steps and function blocks described herein using a processor through the execution of instructions stored in memory in the form of a tangible data storage medium.

What is claimed is:

1. A system comprising:
a mobile vehicle;
a global positioning system (GPS) based vehicle position and heading system supported on the vehicle measures global easting and global northing (measured position) of the vehicle, and determines a heading (measured heading) of the vehicle;
at least one two-dimensional (2D) velocity sensor measures the velocity of the vehicle with respect to the ground, over which the vehicle travels, in two orthogonal directions (measured velocity);
a yaw rate system supported on the vehicle measures a yaw rate of the vehicle (yaw rate measurement); and
a vehicle position and heading estimator comprising at least one processor that computes a position of the vehicle (estimated position) and a heading of the vehicle (estimated heading) based on the measured position, the measured heading, the measured velocity and the yaw rate measurement.

2. The system of claim 1, wherein the vehicle position and heading estimator comprises:
a heuristic filter configured to receive the measured position, update the estimated position and the estimated heading, and determine a measurement error covariance of the measured heading;
a linear Kalman filter configured to compute an optimal estimate of the vehicle heading (optimal heading estimate) and an estimate of a yaw rate system bias based on the measurement error covariance, the measured heading and the yaw rate measurement; and
a position propagator configured to propagate the estimated position based on the updated vehicle position estimate from the heuristic filter, the measured velocity, the yaw rate measurement and the estimated heading.

3. The system of claim 2, wherein:
the heuristic filter operates at a first frequency; and
the position propagator operates at a second frequency, which is higher than the first frequency.

4. The system of claim 2, wherein the heuristic filter determines the measurement error covariance based on at least one metric selected from the group consisting of a GPS quality value corresponding to a quality of the measured position, a distance between the measured position and the estimated position, an accuracy of the measured heading, a derivative of the measured heading with respect to time, and a quality of the measured heading.

5. The system of claim 1, wherein the GPS based vehicle position and heading system comprises:
a first antenna supported on the vehicle; and
a first GPS receiver configured to calculate the measured position based on GPS signals received through the first antenna.

6. The system of claim 5, wherein the GPS based vehicle position and heading system comprises a second antenna supported on the vehicle.

7. The system of claim 6, wherein:
the vehicle comprises an axis; and
the second antenna is displaced a distance from the first antenna measured along the axis.

8. The system of claim 5, wherein the first GPS receiver comprises a dual frequency, carrier phase digital GPS receiver.

9. The system of claim 5, wherein:
the vehicle comprises a longitudinal axis extending approximately parallel to a surface over which the vehicle travels; and
the velocity sensor measures a velocity in a first direction, which is parallel to the longitudinal axis, and a second direction, which is orthogonal to the longitudinal axis.

10. The system of claim 5, wherein the yaw rate system comprises an inertial measurement unit.

11. The system of claim 1, wherein:
the system comprises a plurality of 2D velocity sensors; and
the yaw rate system comprises at least two of the plurality of 2D velocity sensors.

12. A method of estimating a vehicle position comprising:
moving a mobile vehicle;
performing global positioning system (GPS) based measurements at a first frequency using at least one GPS receiver and at least one antenna supported on the vehicle including measuring a position of the vehicle (measured position) and a heading of the vehicle (measured heading); and
between successive GPS based measurements, estimating, at a second frequency that is greater than the first frequency, a position of the vehicle (estimated position) based on the measured position, the measured heading, a two-dimensional (2D) velocity measurement of the vehicle (measured velocity) and a yaw rate measurement of the vehicle, using at least one processor supported on the vehicle.

13. The method of claim 12, wherein estimating, at a second frequency, a position of the vehicle comprises:
determining an initial estimated position of the vehicle based on the measured position;
determining an initial estimated heading of the vehicle based on the measured heading;
calculating a measurement error covariance of the measured heading;
computing an optimal vehicle heading estimate and yaw rate system bias based on the measurement error covariance, the measured heading and the yaw rate measurement;
updating the estimated position based on the previously estimated position, the measured velocity, the yaw rate measurement and the optimal vehicle heading estimate; and
repeating the calculating, computing and updating steps a finite number of times.

14. The method of claim 13, further comprising:
obtaining the velocity measurement using a 2D velocity sensor supported on the vehicle; and
obtaining the yaw rate measurement using a yaw rate system supported on the vehicle comprising one of an inertial measurement unit and a plurality of 2D velocity sensors.

15. The method of claim 13, wherein calculating a measurement error covariance of the vehicle heading measurement comprises calculating a measurement error covariance of the vehicle heading measurement based on at least one metric selected from the group consisting of a GPS quality value corresponding to a quality of the measured position, a distance between the measured position and the estimated position, an accuracy of the measured heading, a derivative of the measured heading with respect to time, and a quality of the measured heading.

16. A method of estimating a vehicle position comprising:
providing a system comprising:
a mobile vehicle;
a global positioning system (GPS) supported on the mobile vehicle;
a heading system supported on the mobile vehicle;
at least one two-dimensional (2D) velocity sensor supported on the vehicle;
a yaw rate system supported on the vehicle; and
a vehicle position and heading estimator supported on the vehicle comprising at least one processor;
moving the mobile vehicle;
calculating global easting and global northing of the vehicle (measured position) using the GPS calculating a heading of the vehicle (measured heading) using the heading system;
measuring a velocity of the vehicle in two orthogonal directions (measured velocity) using the 2D velocity sensor;
measuring a yaw rate of the vehicle (measured yaw rate) using the yaw rate system;
computing an estimated position of the vehicle based on the measured position, the measured heading, the measured velocity and the measured yaw rate using the at least one processor.

17. The method of claim 16, wherein computing an estimated position of the vehicle comprises:
determining an initial estimated position of the vehicle based on the measured position;
determining an initial estimated heading of the vehicle based on the measured heading;
calculating a measurement error covariance of the measured heading;
computing an optimal vehicle heading estimate and yaw rate system bias based on the measurement error covariance, the measured heading and the yaw rate measurement;
updating the estimated position based on the previously estimated position, the measured velocity, the yaw rate measurement and the optimal vehicle heading estimate; and
repeating the calculating, computing and updating steps a finite number of times.

18. The method of claim 16, wherein measuring a yaw rate of the vehicle comprises measuring a yaw rate using an inertial measurement unit supported on the vehicle.

19. The method of claim 16, wherein measuring a yaw rate of the vehicle comprises measuring a yaw rate using a plurality of 2D velocity sensors supported on the vehicle.

20. The method of claim 16, wherein:
a vehicle comprises a longitudinal axis extending approximately parallel to a surface over which the vehicle travels; and
the 2D velocity sensor measures a velocity in a first direction, which is parallel to the longitudinal axis, and a second direction, which is orthogonal to the longitudinal axis.
